(19) United States
(12) Patent Application Publication
(10) Pub. No.: US 2007/0156546 A1
(43) Pub. Date: Jul. 5, 2007

(54) Reconciliation method and apparatus

(76) Inventors: Till Oppert, Worms (DE); Paola Sala, Heidelberg (DE); Georg Podhajsky, Philippsburg (DE); Joachim Welte, Harthausen (DE); Markus Klein, Frankenthal (DE); Wolfgang Barheine, Karlsruhe (DE); Matthias Heinrichs, Speyer (DE); Tanja Soehngen, Altlussheim (DE); Pascal Hochwarth, Muehlhausen (DE); Michael Sylvester, Roemerberg (DE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/322,325

(22) Filed: Dec. 30, 2005

(51) Int. Cl. G07F 19/00

(52) U.S. Cl. 705/30

(57) ABSTRACT

A method includes selecting a set of transaction records from an accounting function, selecting a set of transaction records from a logical deployment unit, and checking the set of transaction records from the accounting function against the set of transaction records from a logical deployment unit, wherein the accounting function is separate from the logical deployment unit. A system includes a logical deployment unit, an accounting component separate from the logical deployment unit, a messaging system for sending messages from the logical deployment unit to the accounting component, and a checking mechanism.

### BACKGROUND

In complex business management systems, transactions may be handled by many different parts of the system. Operations components of systems may be responsible for receiving orders, shipping, checking invoices, tracking payments and providing information to an accounting system. In some systems, the accounting function may be separate from the operations components. Such systems can be very complex, and it is difficult to track business transactions that may flow through the system. Customers require the ability to check the financial and accounting function against the actual transactions occurring in an operations component. Customers need assurance that the system landscape is consistent. Customers also need assurance that the data storages in the system landscape are consistent.

Furthermore, regulatory bodies generally require the ability to check the financial and accounting function against the actual transactions occurring in an operations component. Inconsistent data, or missing reconciliation reports have a sever impact on regulatory compliance as well as the auditability of the system. As a result, the ability to check the financial and accounting function against the actual transactions occurring in an operations component is needed. In addition, the ability to reconcile differences between the financial and accounting function and the actual transactions occurring in an operations component is also needed in a system where the accounting and financial function is separated from the operations components.

### BRIEF DESCRIPTION OF THE DRAWINGS

FIG. 1 is a block diagram of an overall computing environment, according to an example embodiment.

FIG. 2 is a block diagram illustration of a value chain with prima nota and single point inventory objects, according to an example embodiment.

FIG. 3 is a flow diagram of a method for reconciling a set of transaction records from an accounting function with set of transaction records from a logical deployment unit, according to an example embodiment.

FIG. 4 is a flow diagram of a method for selecting a set of transaction records from an accounting function and selecting a set of transaction records from a logical deployment unit, according to an example embodiment.

FIG. 5 is a flow diagram of a method for checking a set of transaction records from an accounting function with set of transaction records from a logical deployment unit, according to an example embodiment.

FIG. 6 is a flow diagram of a method for checking a set of transaction records from an accounting function with set of transaction records from a logical deployment unit, according to an example embodiment.

FIG. 7 is a schematic of a computer checking mechanism, according to an example embodiment.

FIG. 8 is a schematic of a computer system that executes programming, according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

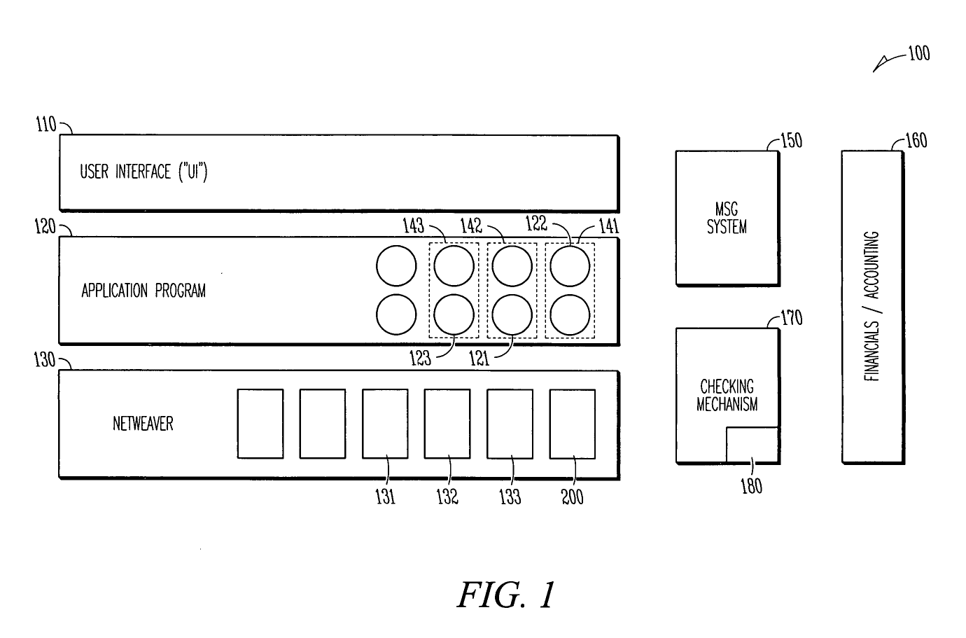

FIG. 1 is a block diagram of a computing system 100, according to an example embodiment. The computing environment 100 includes a user interface 110, an application program level 120 and a comprehensive integration and application platform layer 130. The comprehensive integration and application platform layer works with an existing infrastructure to enable and manage change. The comprehensive integration and application platform 130 includes a plurality of business applications, known as business components, which reduce the need for custom integration. The comprehensive integration and application platform includes a business component 131, 132, and 133. The comprehensive integration and application platform 130 also includes a business component 200, which includes various integration tools for performing business analysis on business information within the computing environment 100. The application program layer 120 also includes a number of distributed objects 121, 122, 123, 124. The object is a technical representation of a concept that includes data and logic. In one example embodiment, the object, such as object 121, 122, 123, 124 is referred to as a business object and is a technical representation of a business concept that includes data and logic. As shown, the business objects 121, 122, 123, 124 can be grouped into logical deployment units, such as logical deployment units 141, 142, 143. A logical deployment unit is a grouping of business objects that perform tasks related to a function. As shown, the system also includes a messaging system 150 that passes messages from the logical deployment units 141, 142, 143 to a financial and accounting component 160. When a message comes from a logical deployment unit it may actually be coming from a business object within the logical deployment unit. For example, a message from the logical deployment unit 141 may actually be coming from the business object 121 or from the business object 122 within the logical deployment unit 141. In one example embodiment, the logical deployment units 141, 142, 143 correspond to groupings of business objects that handle financial transactions such as orders, delivery, invoicing, due management, and payment. The logical deployment units 141, 142, 143 are separate from the financial and accounting component 160 and the messages, in one example embodiment, are passed from the logical deployment units 141, 142, 143 to the financial and accounting component as the transactions occur. The system 100 also includes a checking mechanism 170 that includes a reconciliation module 180. The checking mechanism 170 compares a first set of transaction records from the accounting and financial component 160 to a second set of transaction records from at least one of the logical deployment units 141, 142, 143. The reconciliation module 180 reconciles inconsistencies between the first set of transaction records and the second set of transaction records.

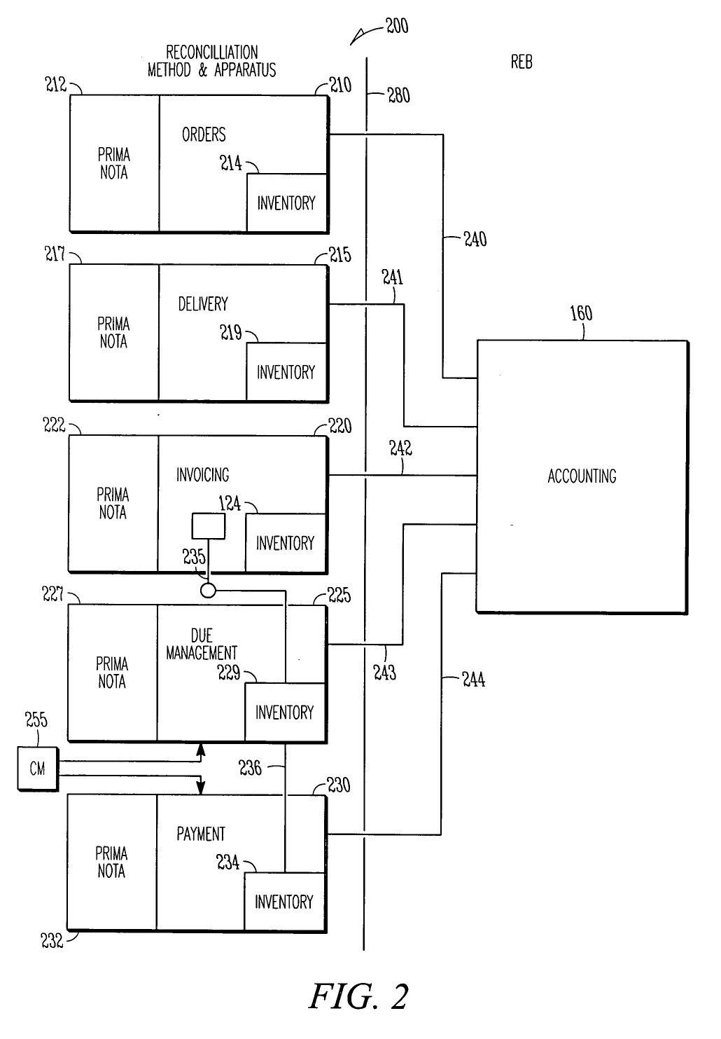

FIG. 2 is a block diagram illustration of a value chain 200 with prima nota and single point inventory business objects, according to an example embodiment. The value chain 200 is a portion of the computing environment 100 that includes logical deployment units that produce transaction records that are sent to the accounting and finance component 160 by way of the messaging system 150. Of course, the accounting and finance component 160 can also receive messages from other logical deployment units outside the value chain 200. Selected logical deployment units in the value chain 200 include an orders logical deployment unit, 210, a delivery logical deployment unit 215, an invoicing logical deployment unit 220, a due management logical deployment unit 225 and a payment logical deployment unit 230. Orders logical deployment unit 210 may include prima nota 212 and an order inventory object 214. The prima nota 212 consists of images of original business documents, such as actual customer orders and contracts in one embodiment. These are the original business documents, and in one embodiment, are assigned a unique internal identification or representation such as a string of numbers and/or characters, to ensure proper referencing. While such prima nota 212 are the primary business documents, copies of them may be provided if desired.

Order inventory object 214 may include an inventory of all current unshipped orders in one embodiment. It is updated by the use of messages generated as a result of transactions. A transaction may be performed by the orders logical deployment unit 210 in response to receipt of an order. A message to update the inventory object 214 may also result from a delivery transaction via delivery logical deployment unit 215.

Delivery logical deployment unit 215 may also include prima nota 217 that contains primary business documents, such as delivery documents, and a delivery inventory 219, which again may be updated via messages generated by transactions from one or more logical deployment units.

Invoicing logical deployment unit 220 may also include prima nota 222 that contains primary copies of invoices and other business documents related to functions that the invoicing logical deployment unit 220 performs. Invoicing logical deployment unit 220 may also contain an inventory object 224 that contains a single point of inventory for invoices. The transactions may result in increases and reductions in the inventory of inventory object 224.

Due management logical deployment unit 225 may also include prima nota 227, such as documents related to amounts due from business partners, collections notices, etc. Due management logical deployment unit 225 may also include a due inventory object that represents amounts due from business partners. It may be updated via messages resulting from transactions in various logical deployment units, such as invoicing via the invoicing logical deployment unit as represented by line 235. It may also be updated by messages generated from payments received via payment logical deployment unit 230.

Payment logical deployment unit 230 may also include prima nota 232, such as documents related to payments. Payments may take many different forms, such as cash, check, money order, credit card, offsets, and electronic funds transfer. The prima nota may be scanned copies of checks, or associated communications with such payments. The payments are transactions that are processed by the payment logical deployment unit 230 and result in messages incrementing and decrementing a payment register inventory object 234.

In one embodiment, the logical deployment units perform transactions that modify one or more inventory objects, and also may result in communications of such transactions in the form of messages as indicated at 240, 241, 242, 243 and 244 being sent to a separate accounting and finance system 160, as indicated by messages 240, 241, 242, 243, 244 being sent to the accounting and finance system 160. The accounting and finance system 160, in some embodiments, may also be an additional deployment unit. The business operations or value chain 200 and the logical deployment units within the value chain 200 is a separate system from the accounting and finance system 160 as depicted by a line 280 in FIG. 2. Simply stated, the accounting and finance system is separate from the operational system. The operational systems are also integrated by messages and not by a data base. These separate systems communicate back and forth via messages. In one embodiment, the business operations system 200 is a cash based system, where cash is calculated in real time. The accounting system may operate on an accrual basis. The operational systems operate with transactional/nominal values, such as quantities, transaction amounts, and the like. The accounting and finance system 160 operates with valuated values, such as amounts in group currency, amounts in company currency, or the like. By using messages between these two different systems, and keeping business documents and inventory separate in the operations system, each system is free to select how to handle transactions.

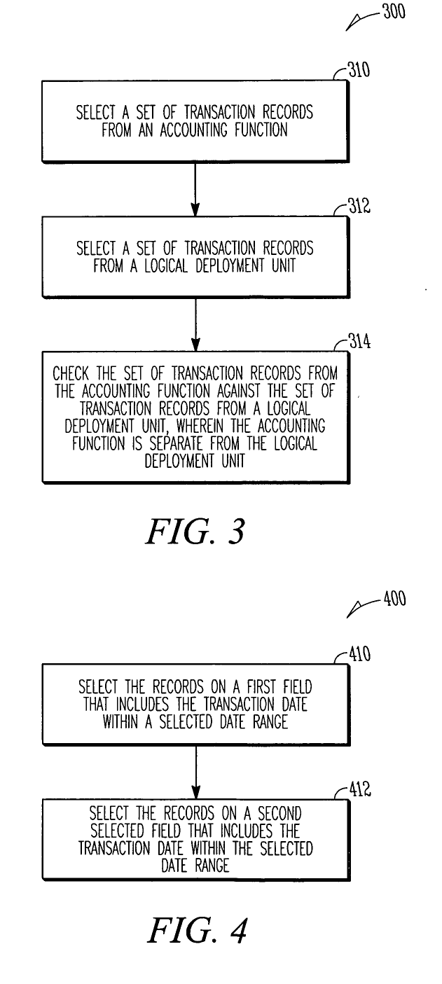

FIG. 3 is a flow diagram of a method 300 for reconciling a set of transaction records from an accounting function with set of transaction records from a logical deployment unit, according to an example embodiment. The method 300 includes selecting a set of transaction records from an accounting function 310, selecting a set of transaction records from a logical deployment unit 312, and checking the set of transaction records from the accounting function against the set of transaction records from a logical deployment unit, wherein the accounting function is separate from the logical deployment unit 314. Selecting a set of transaction records from an accounting function includes sorting the records on a first selected field. Selecting a set of transaction records from a logical deployment unit includes sorting the records on a second selected field that includes the same type of information as the first selected field.

FIG. 4 is a flow diagram of a method 400 for selecting a set of transaction records from an accounting function 310 and selecting a set of transaction records from a logical deployment unit 312, according to an example embodiment. Selecting a set of transaction records from an accounting function includes selecting the records on a first field that includes the transaction date within a selected date range 410. Selecting a set of transaction records from a logical deployment unit includes selecting the records on a second selected field that includes the transaction date within the selected date range 412. It should be noted that the range of dates can be one day. In addition, the selected date range can include a selected time within a day, or can include a plurality of days. The range of dates is equal for the transaction records from the accounting function and the transaction records from a logical deployment unit. In some embodiments, other fields can also be sorted on including an outside company and an internal division that does business with the outside company. The fields on the records can, therefore, be used to narrow the number of transaction records that need to be reconciled. This is useful in providing auditability to the system 100 (see FIG. 1).

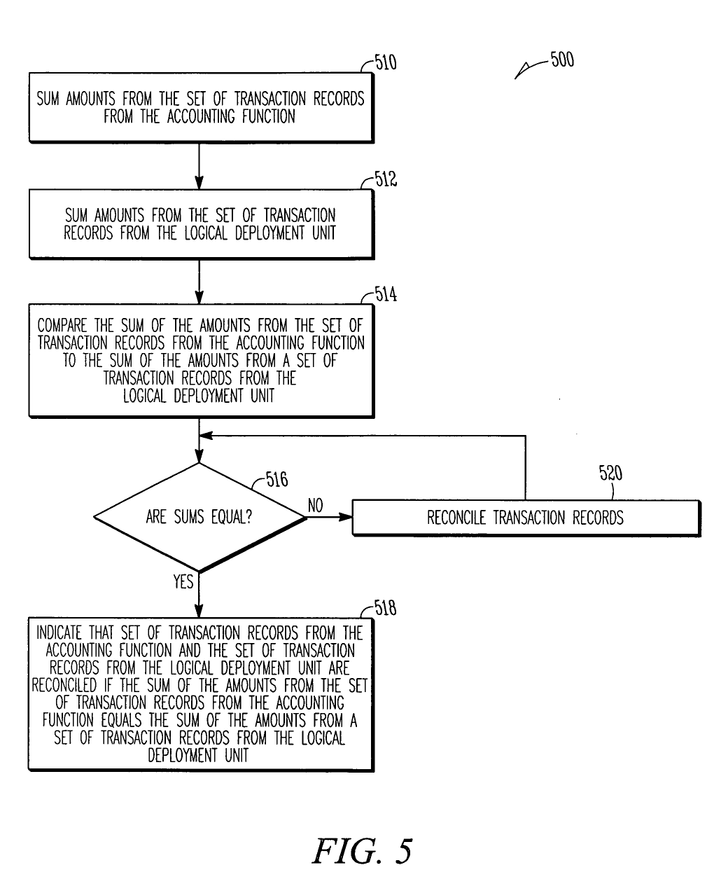

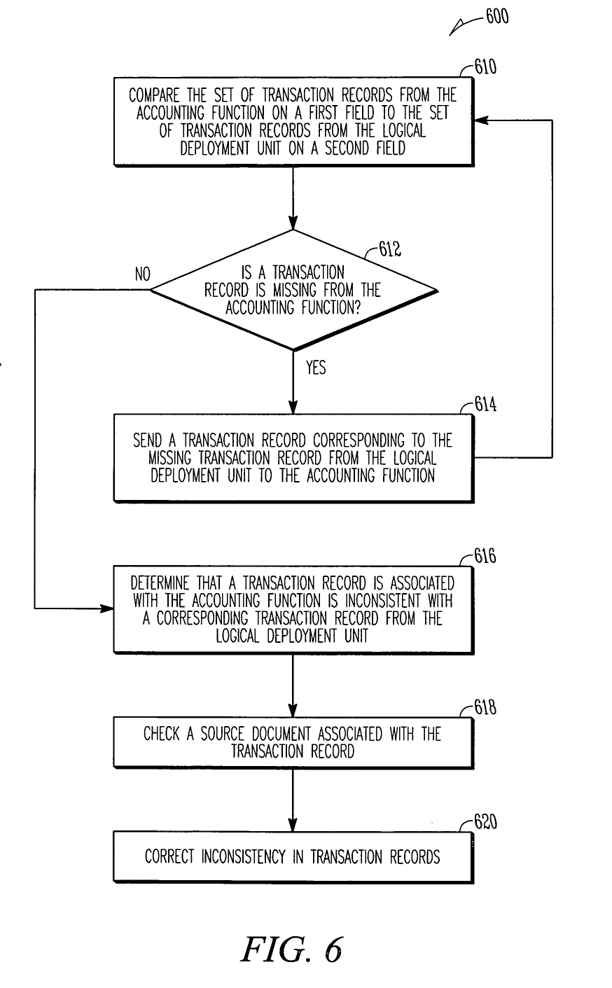

Several methods can be employed for checking the set of transaction records from the accounting function against the set of transaction records from a logical deployment unit, wherein the accounting function is separate from the logical deployment unit. FIG. 5 shows one embodiment for checking transaction records. FIG. 5 is a flow diagram of a method 500 for checking a set of transaction records from an accounting function with set of transaction records from a logical deployment unit, according to an example embodiment. The method 500 includes summing amounts from the set of transaction records from the accounting function 510, and summing amounts from the set of transaction records from the logical deployment unit 512. The checking method 500 also includes comparing the sum of the amounts from the set of transaction records from the accounting function to the sum of the amounts from a set of transaction records from the logical deployment unit 514. A decision box 516 denotes a determination of whether the sums are equal. If the sum of the amounts from the set of transaction records from the accounting function equals the sum of the amounts from a set of transaction records from the logical deployment unit, the checking method 500 includes indicating that set of transaction records from the accounting function and the set of transaction records from the logical deployment unit are reconciled 518. If the sum of the amounts are not equal, then the transaction records need to be reconciled 520. One such method is set forth in FIG. 6 which is further detailed below.

FIG. 6 is a flow diagram of a method 600 for checking a set of transaction records from an accounting function with set of transaction records from a logical deployment unit, according to another example embodiment. Checking the set of transaction records from the accounting function against the set of transaction records from a logical deployment unit includes comparing the set of transaction records from the accounting function on a first field to the set of transaction records from the logical deployment unit on a second field 610. A decision box 612 denotes a determination of whether a transaction record is missing from the accounting component. If it is determined that a transaction record is missing from the accounting function, the transaction record corresponding to the missing transaction record is sent from the logical deployment unit to the accounting function 614. A workflow task is sent to the accounting function or to an accountant, which can trigger a document flow to analyze the reasons for the detected inconsistency. If it is determined that a transaction record is associated with the accounting function is inconsistent with a corresponding transaction record from the logical deployment unit 616, then a source document associated with the transaction record may be checked 618. The method 600 also includes changing at least one of the transaction record associated with the accounting function or the transaction record at the logical deployment unit to resolve the inconsistency 620. Turning briefly to FIG. 1, checking the source document 618 includes delivering an appropriate prima nota 212, 217, 222, 227, 232 from the appropriate logical deployment unit 210, 215, 220, 225, 230, respectively. The prima nota 212, 217, 222, 227, 232, in one embodiment, may be viewable at a user interface 110. In another embodiment, the prima nota 212, 217, 222, 227, 232 may be sent to the checking mechanism 170 and specifically the reconciliation module 180 for comparison to the transaction records of the logical deployment unit or the financial and accounting component 160.

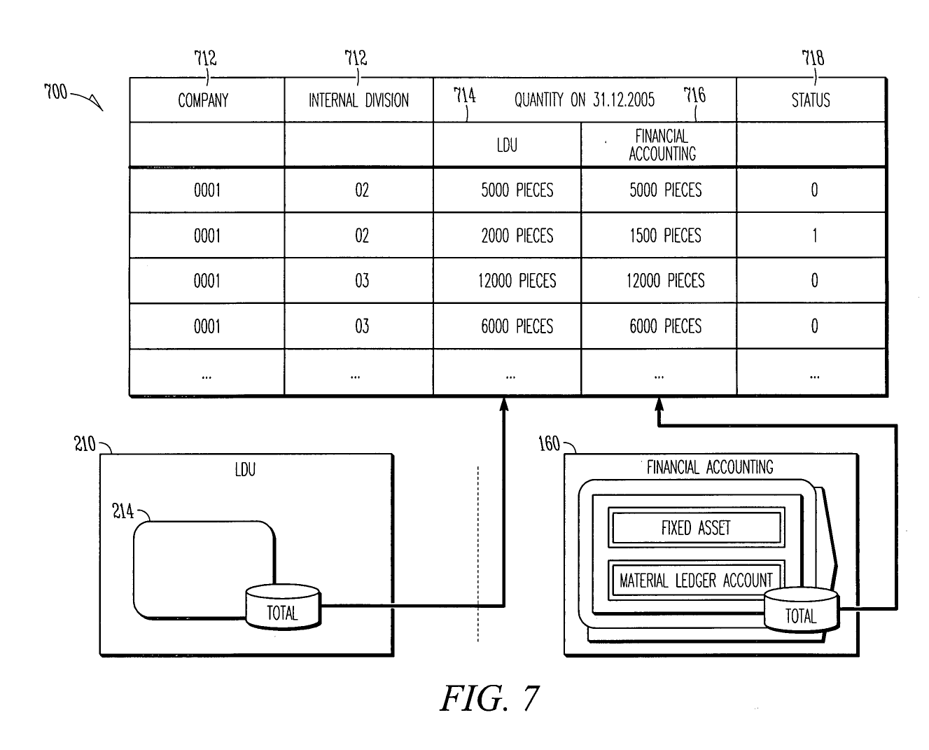

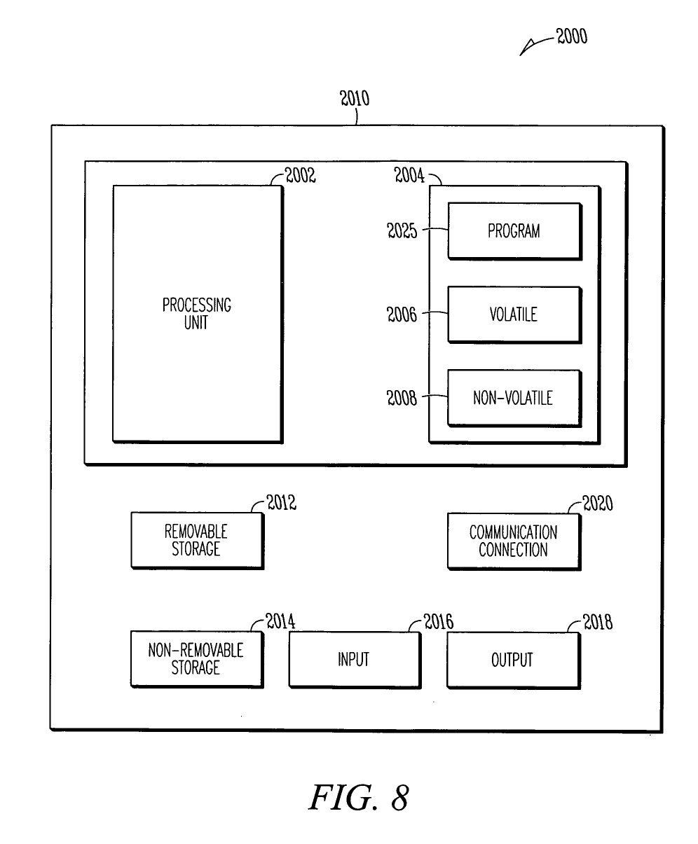

FIG. 7 is a schematic of a computer checking mechanism 700, according to an example embodiment. The computer checking mechanism 700 is in the form of a spreadsheet that includes a plurality of columns 710, 712, 714, 714, 718. Column 714 includes inventory information from an logical deployment unit 210 for a plurality of records. More specifically form the inventory portion 214, of the logical deployment unit 210 provides the inventory amounts associated with transaction records for the selected date (Oct. 31, 2005). Column 716 of the computer checking mechanism 700 also includes inventory information from the financial and accounting component 160 for a selected date (Oct. 31, 2005). The computer checking mechanism 700 also includes company information in column 710, internal division in column 712, and a status in column 718. Using this checking mechanism, inventory records can be matched and inconsistencies can be found as indicated by a “1” in the status column 718. The status column 718 can also be used to find missing records in either the logical deployment unit 210 or the financial and accounting component 160.

A block diagram of a computer system 2000 that executes programming for performing the above algorithm is shown in FIG. 9, according to an example embodiment. A general computing device in the form of a computer 2010, may include a processing unit 2002, memory 2004, removable storage 2012, and non-removable storage 2014. Memory 2004 may include volatile memory 2006 and non-volatile memory 2008. Computer 2010 may include, or have access to a computing environment that includes, a variety of computer-readable media, such as volatile memory 2006 and non-volatile memory 2008, removable storage 2012 and non-removable storage 2014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 2010 may include or have access to a computing environment that includes input 2016, output 2018, and a communication connection 2020. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 2002 of the computer 2010. A hard drive, CD-ROM, and RAM are some examples of articles including a computer-readable medium. For example, a computer program 2025 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer system 2000 to provide generic access controls in a COM based computer network system having multiple users and servers.

A computer readable medium having instructions for causing a computer to perform a method including selecting a set of transaction records from an accounting function, and selecting a set of transaction records from a logical deployment unit. The computer readable medium also causes the computer to check the set of transaction records from the accounting function against the set of transaction records from a logical deployment unit, wherein the accounting function is separate from the logical deployment unit. Accounting functions and operational functions are distributed over many logical deployment units. In some example embodiments, the computer readable medium includes instructions for causing a computer to select a set of transaction records from the accounting function that includes the transaction records on a first field with the transaction date within a selected date range. The computer readable medium also includes instructions for causing a computer to select a set of transaction records from the logical deployment unit that includes the transaction records on a second field with the transaction date within a selected date range.

The computer readable medium, in some example embodiments, has instructions for causing a computer to check the set of transaction records from the accounting function against the set of transaction records from a logical deployment unit by summing amounts from the set of transaction records from the accounting function, summing amounts from the set of transaction records from the logical deployment unit, and comparing the sum of the amounts from the set of transaction records from the accounting function to the sum of the amounts from a set of transaction records from the logical deployment unit. In another example embodiment, the computer readable medium has instructions for causing a computer to check the set of transaction records from the accounting function against the set of transaction records from a logical deployment unit by comparing the set of transaction records from the accounting function on a first field to the set of transaction records from the logical deployment unit on a second field. The computer readable medium also causes the computer to determine that a transaction record is missing from the accounting function, and to send a transaction record corresponding to the missing transaction record from the logical deployment unit to the accounting function. In other example embodiments, the computer readable medium can also cause a computer to determine that a transaction record is associated with the accounting function is inconsistent with a corresponding transaction record from the logical deployment unit, and to check a source document associated with the transaction record.

The computer readable medium can also include instructions for implementing any or all of the other steps of the methods 300, 400, 500, or 600 discussed above.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A method comprising:
selecting a set of transaction records from an accounting function;
selecting a set of transaction records from a logical deployment unit; and
checking the set of transaction records from the accounting function against the set of transaction records from a logical deployment unit, wherein the accounting function is separate from the logical deployment unit.

2. The method of claim 1 wherein selecting a set of transaction records from an accounting function includes sorting the records on a first selected field.

3. The method of claim 2 wherein selecting a set of transaction records from a logical deployment unit includes sorting the records on a second selected field that includes the same type of information as the first selected field.

4. The method of claim 1 wherein selecting a set of transaction records from an accounting function includes
selecting the records on a first field that includes the transaction date within a selected date range.

5. The method of claim 4 wherein selecting a set of transaction records from a logical deployment unit includes
selecting the records on a second selected field that includes the transaction date within the selected date range.

6. The method of claim 1 wherein checking the set of transaction records from the accounting function against the set of transaction records from a logical deployment unit includes
summing amounts from the set of transaction records from the accounting function;
summing amounts from the set of transaction records from the logical deployment unit; and
comparing the sum of the amounts from the set of transaction records from the accounting function to the sum of the amounts from a set of transaction records from the logical deployment unit.

7. The method of claim 6 further comprising indicating that set of transaction records from the accounting function and the set of transaction records from the logical deployment unit are reconciled if the sum of the amounts from the set of transaction records from the accounting function equals the sum of the amounts from a set of transaction records from the logical deployment unit.

8. The method of claim 1 wherein checking the set of transaction records from the accounting function against the set of transaction records from a logical deployment unit includes comparing the set of transaction records from the accounting function on a first field to the set of transaction records from the logical deployment unit on a second field.

9. The method of claim 8 including
determining that a transaction record is missing from the accounting function; and
sending a transaction record corresponding to the missing transaction record from the logical deployment unit to the accounting function.

10. The method of claim 8 further comprising:
determining that a transaction record is associated with the accounting function is inconsistent with a corresponding transaction record from the logical deployment unit; and
checking a source document associated with the transaction record.

11. The method of claim 10 further comprising changing at least one of the transaction record associated with the accounting function or the transaction record at the logical deployment unit to resolve the inconsistency.

12. A computer readable medium having instructions for causing a computer to perform a method comprising:
selecting a set of transaction records from an accounting function;
selecting a set of transaction records from a logical deployment unit; and
checking the set of transaction records from the accounting function against the set of transaction records from a logical deployment unit, wherein the accounting function is separate from the logical deployment unit.

13. The computer readable medium of claim 12 having instructions for causing a computer to perform a method wherein selecting a set of transaction records from the accounting function includes selecting the records on a first field that includes the transaction date within a selected date range.

14. The computer readable medium of claim 13 having instructions for causing a computer to perform a method wherein selecting a set of transaction records from the logical deployment unit includes selecting the records on a second field that includes the transaction date within the selected date range.

15. The computer readable medium of claim 12 having instructions for causing a computer to perform a method wherein checking the set of transaction records from the accounting function against the set of transaction records from a logical deployment unit includes
summing amounts from the set of transaction records from the accounting function;
summing amounts from the set of transaction records from the logical deployment unit; and
comparing the sum of the amounts from the set of transaction records from the accounting function to the sum of the amounts from a set of transaction records from the logical deployment unit.

16. The computer readable medium of claim 12 having instructions for causing a computer to perform a method wherein checking the set of transaction records from the accounting function against the set of transaction records from a logical deployment unit includes comparing the set of transaction records from the accounting function on a first field to the set of transaction records from the logical deployment unit on a second field.

17. The computer readable medium of claim 16 having instructions for causing a computer to perform a method including
determining that a transaction record is missing from the accounting function; and
sending a transaction record corresponding to the missing transaction record from the logical deployment unit to the accounting function.

18. The computer readable medium of claim 16 having instructions for causing a computer to perform a method including
determining that a transaction record is associated with the accounting function is inconsistent with a corresponding transaction record from the logical deployment unit; and
checking a source document associated with the transaction record.

19. A system comprising:
a logical deployment unit including a first set of transaction records;
an accounting component separate from the logical deployment unit including a second set of transactions records corresponding to the first set of transaction records;
a messaging system for sending messages from the logical deployment unit to the accounting component, the messaging system sending messages of transactions as they occur to form the second set of transaction records; and
a checking mechanism for comparing a first set of transaction records from the accounting component to a second set of transaction records from the logical deployment unit.

20. The system of claim 19 further comprising a reconciliation module that reconciles inconsistencies between the first set of transaction records and the second set of transaction records.
